(19) United States
(12) Patent Application Publication
(10) Pub. No.: US 2012/0103649 A1
(43) Pub. Date: May 3, 2012

(54) ELECTRICAL JUNCTION BOX

(75) Inventor: Masahiro TAGANO, Yokkaichi-city (JP)

(73) Assignee: SUMITOMO WIRING SYSTEMS, LTD., Yokkaichi-city (JP)

(21) Appl. No.: 13/079,414

(22) Filed: Apr. 4, 2011

(30) Foreign Application Priority Data
Oct. 27, 2010 (JP) 2010-240915

(51) Int. Cl. H02G 3/08

(52) U.S. Cl. 174/50

(57) ABSTRACT

An electrical junction box configured to position and hold a tapered connecting terminal in a terminal containing section stably without deteriorating a connecting operation. The electrical junction box may include a terminal containing section provided on its inner surfaces with a plurality of outer ribs and side ribs that protrude from the inner surfaces and extend in an inserting direction of a connecting terminal. Protruding dimensions of the outer ribs gradually increases as the outer ribs extend to a distal end side of the connecting terminal. The outer ribs pinch the connecting terminal from both its outer sides in a first direction of a pair of pinching pieces of the connecting terminal while the side ribs pinch the connecting terminal from its both outer sides in a direction perpendicular to the first direction, thereby positioning the connecting terminal in the terminal containing section.

### BACKGROUND

This disclosure generally relates to an electrical junction box that includes a terminal containing section in which a connecting terminal is inserted and held, and more particularly relates to an electrical junction box in which a tapered connecting terminal is inserted and held.

An electrical junction box, such as a relay box or a fuse box, may be provided with a connecting terminal to be connected to an electrical component, such as a relay or a fuse. For example, as disclosed in JP 2003-274538 A, a connecting terminal may be inserted into and held in a terminal containing section provided in an electrical junction box so as to be connected to a tab terminal of a relay, a fuse, or the like.

The connecting terminal may be formed into various kinds of configurations. For example, as disclosed in JP 2008-34402 A, the connecting terminal is provided on its distal end with a pair of pinching pieces that approach to each other. A tab terminal of an electrical component is pushed into a space between the pair of pinching pieces so that the pair of pinching pieces pinch the tab terminal to couple the tab terminal to the connecting terminal.

However, the connecting terminal disclosed in JP 2008-34402 A is tapered since the pair of pinching pieces approach to each other toward their distal end side. Accordingly, when the connecting terminal is attached to the electrical junction box, a large clearance results between the pinching pieces and an inner surface of the terminal containing section. Therefore, the connecting terminal may stagger or shift within the terminal containing section on account of the clearance. As a result, the reliability of the connection with the electrical component decreases.

Further, the interior of the terminal containing section may be tapered so as to correspond to the tapered connecting terminal in order to prevent the connecting terminal from staggering within the terminal containing section. However, in such structure, since the pinching pieces of the connecting terminal contact with an inner surface of the terminal containing section and the pinching pieces cannot be widened sufficiently when the electrical component is coupled to the connecting terminal, there is a possibility that the connection will be deteriorated. Also, when the connecting terminal is assembled in the terminal containing section, the connecting terminal rubs the inner surface of the terminal containing section, thereby requiring a large inserting force for the connecting terminal. This will deteriorate workability in assembly. Furthermore, there is a problem that it is difficult to form a tapered inner surface in the terminal containing section and an amount of resin increases on account of a narrow interior of the terminal containing section.

### SUMMARY

Exemplary embodiments can provide an electrical junction box that positions and stably holds a tapered connecting terminal in a terminal containing section without deteriorating workability in the connection of the connecting terminal.

In the exemplary embodiments, an electrical junction box may include a terminal containing section in which a connecting terminal to be connected to an electrical component is inserted and held. The connecting terminal may be tapered and may be provided with a pair of pinching pieces that are stacked on each other. A tab terminal of the electrical component is pinched between the pair of pinching pieces. The terminal containing section is provided on an inner surface thereof with a plurality of outer ribs and a plurality of side ribs that protrude from the inner surface and extend in an inserting direction of the connecting terminal. Protruding dimensions of the outer ribs gradually increase as the outer ribs extend toward a distal end side of the connecting terminal. The outer ribs pinch the connecting terminal from both outer sides thereof in a stacking direction of the pair of pinching pieces while the side ribs pinch the connecting terminal from both outer sides thereof in a direction perpendicular to the stacking direction, thereby positioning the connecting terminal in the terminal containing section.

According to the electrical junction box in the exemplary embodiments, the connecting terminal accommodated in the terminal containing section may be pinched by the outer ribs and side ribs provided on the inner surface of the terminal containing section. Particularly, the protruding dimensions of the outer ribs gradually increase as the outer ribs extend toward the distal end side of the connecting terminal. Thus, it is possible for the interior of the terminal containing section to accord with the tapered connecting terminal by making the protruding dimensions of the outer ribs gradually increase in connection with the structure in which the pinching pieces of the connecting terminal are gradually spaced apart from the inner surface of the terminal containing section. As a result, even if the connecting terminal is tapered, the outer ribs and side ribs can reduce the clearance between the connecting terminal and the inner surface of the terminal containing section and can position the connecting terminal in the terminal containing section while restraining the connecting terminal from staggering in the terminal containing section. Furthermore, the connecting terminal can be pinched by the outer ribs and side ribs in two orthogonal directions. Thus, it is also possible to effectively prevent the connecting terminal from staggering in a rotary direction.

Since the outer ribs pinch the pinching pieces from their both sides in opening and closing directions of the pinching pieces, it is possible to prevent the pinching pieces from being widened excessively while ensuring an amount of widening deformation of the pinching pieces required when the electrical component is coupled to the connecting terminal. At the same time, since the side ribs pinch the pinching pieces from their both sides in a direction perpendicular to the opening and closing directions, it is possible to prevent the connecting terminal from staggering in the terminal containing section while restraining the opening and closing operations of the pinching pieces from being deteriorated. Consequently, it is possible to ensure workability in connection of the connecting terminal and it is possible to stably position the connecting terminal in the terminal containing section.

When the connecting terminal is inserted into the terminal containing section, the outer ribs and side ribs can reduce a sliding area between the connecting terminal and the inner surface of the terminal containing section. Thus, it is possible for a small insertion force to easily insert the connecting terminal into the terminal containing section and it is possible to prevent the connecting terminal from staggering in the terminal containing section. Furthermore, since the outer ribs and side ribs merely protrude from the inner surface of the terminal containing section, it is easy to form the interior of the terminal containing section and it is possible to reduce an amount of resin in comparison with the case where the entire interior of the terminal containing section is narrowed in connection with the tapered connecting terminal.

In the electrical junction box of the exemplary embodiments, the terminal containing section may be provided on the inner surface with an engaging and holding section that latches the connecting terminal. The connecting terminal may be pinched between the engaging and holding section and one of the outer ribs.

In the exemplary embodiments, since the engaging and holding section can latch the connecting terminal, it is possible to hold the connecting terminal in the terminal containing section. Since the outer rib is opposed to the engaging and holding section and the engaging and holding section and outer ribs pinch the connecting terminal, it is possible to hold the connecting terminal in the terminal containing section more stably.

In the electrical junction box of the exemplary embodiments, the outer ribs may be greater than the side ribs over the entire lengths of the outer ribs.

Accordingly, the greater outer ribs in the opening direction of the pinching pieces can stably prevent the pinching pieces from being widened excessively in the opening direction while the smaller side ribs in a side direction of the pinching pieces can prevent the pinching pieces from staggering in the terminal containing section without deteriorating the opening and closing actions of the pinching pieces.

In the electrical junction box of the exemplary embodiments, the outer ribs may be brought into contact with the faces of the pinching pieces of the connecting terminal, while the side ribs may be brought into point contact with the pinching pieces.

Accordingly, since the outer ribs may be brought into contact with the faces of the pinching pieces, it is possible to more effectively prevent the pinching pieces from being widened excessively. At the same time, since the side ribs may be brought into point contact with the pinching pieces, it is possible to reduce a contact area between the side ribs and the pinching pieces and it is possible to reduce deterioration of the pinching pieces when the pinching pieces are opened.

In the exemplary embodiments, the inner surface of the terminal containing section may be provided with the outer ribs and side ribs, and the protruding dimensions of the outer ribs from the inner surface gradually increase as the outer ribs extend toward the distal end side of the connecting terminal. The outer ribs and side ribs pinch the connecting terminal in two orthogonal directions. Thus, it is possible to stably position and hold the connecting terminal in the terminal containing section. Furthermore, since the outer ribs pinch the pinching pieces from their both sides in the opening and closing directions of the pinching pieces, it is possible to prevent the pinching pieces from being widened excessively while ensuring an amount of widening the pinching pieces required for connecting the electrical component to the connecting terminal. At the same time, since the side ribs pinch the pinching pieces from their both sides in the direction perpendicular to the opening and closing directions, it is possible to lower deterioration of the opening and closing actions of the pinching pieces. In result, it is possible to position the connecting terminal while ensuring workability in connection of the connecting terminal.

### BRIEF DESCRIPTION OF THE DRAWINGS

FIG. 1 is a top plan view of an electrical junction box according to an exemplary embodiment;

FIG. 2 is a top plan view of a terminal containing section provided in the electrical junction box shown in FIG. 1;

FIG. 3 is a bottom plan view of the terminal containing section shown in FIG. 2;

FIG. 4 is a cross section view of the terminal containing section taken along lines IV-IV in FIG. 2;

FIG. 5 is a longitudinal section view of the terminal containing section taken along lines V-V in FIG. 2;

FIG. 6 is a perspective view of a connecting terminal to be accommodated in the terminal containing section shown in FIG. 2;

FIG. 7 is a rear side elevation view of the connecting terminal shown in FIG. 6;

FIG. 8 is a side elevation view of the connecting terminal shown in FIG. 6;

FIG. 9 is a longitudinal section view of the connecting terminal corresponding to FIG. 4, illustrating the connecting terminal accommodated in the terminal containing section; and

FIG. 10 is a longitudinal section view of the connecting terminal corresponding to FIG. 5, illustrating the connecting terminal accommodated in the terminal containing section.

### DETAILED DESCRIPTION OF EMBODIMENTS

Referring now to the drawings, exemplary embodiments of an electrical junction box will be described below.

FIG. 1 shows an electrical junction box 10 in an exemplary embodiment. The electrical junction box 10 is formed into a substantially rectangular box-like configuration made of a synthetic resin. The electrical junction box 10 is provided with a relay mounting unit 12 on which an electrical component (not shown) such as a relay is mounted. The relay mounting unit 12 is provided with terminal containing sections 14 at positions corresponding to tab terminals provided on the relays.

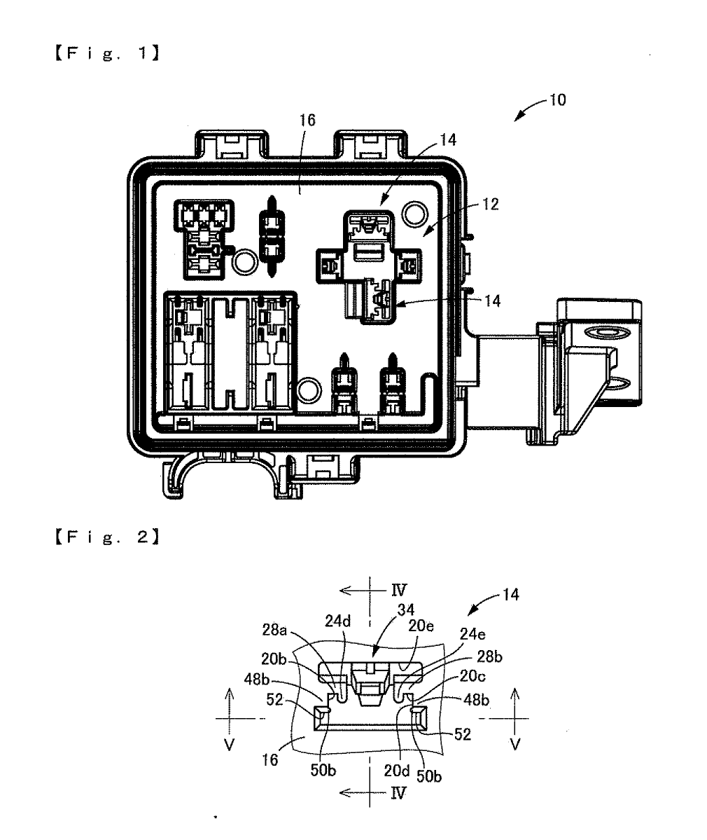

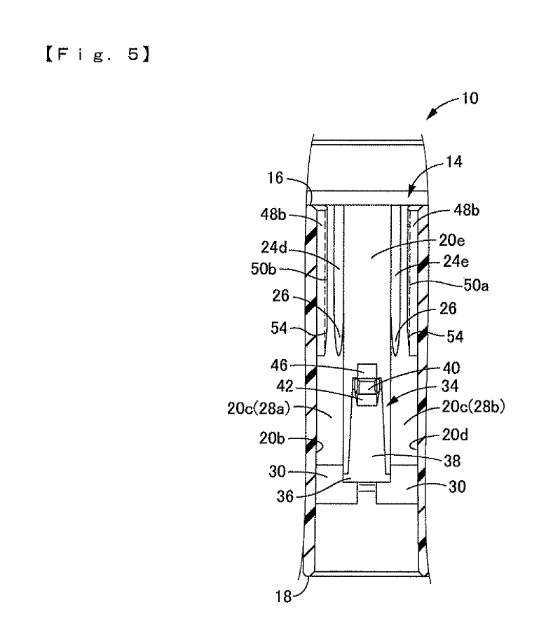

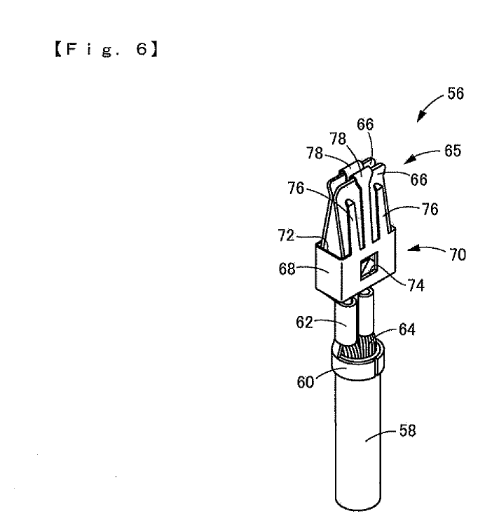

FIGS. 2 to 5 show each of the terminal containing sections 14. Each terminal containing section 14 extends in a thickness direction (upper and lower directions in FIGS. 4 and 5) and defines a through-hole that is open in a front surface and a rear surface of the electrical junction box 10. An extending direction of the terminal containing section 14 accords with an inserting direction of a connecting terminal 56 (mentioned after) so that the connecting terminal 56 is inserted into the electrical junction box 10 from a rear surface 18 to a front surface 16. Each terminal containing section 14 is formed into a substantially rectangular through-hole having inner surfaces 20a to 20d. The inner surfaces 20a and 20c are opposed to each other while the inner surfaces 20b and 20d are opposed to each other in a direction perpendicular to the facing direction of the inner surfaces 20a and 20e.

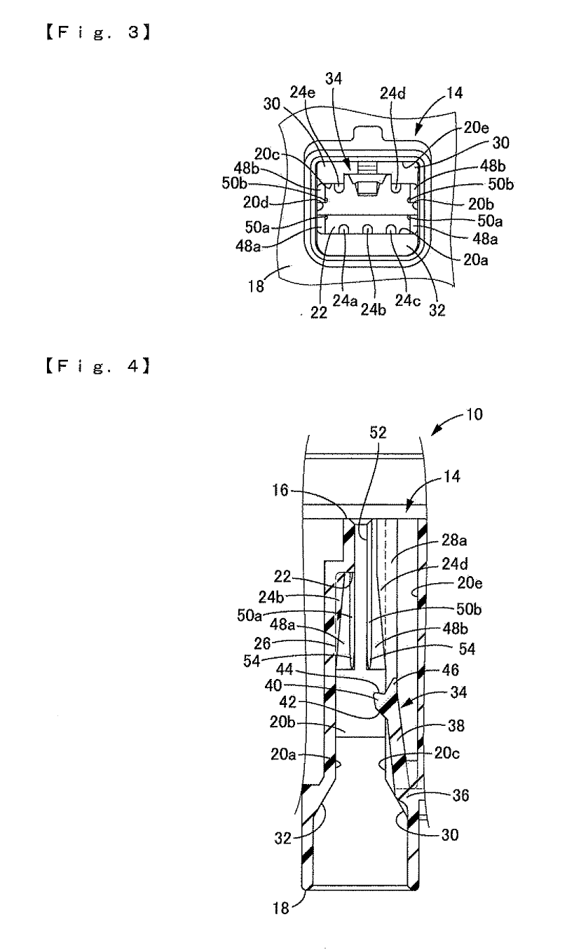

As shown in FIG. 4, the inner surface 20a is provided at a side of the front surface 16 with a stepped surface 22 that protrudes vertically toward an inside of the terminal containing section 14. The stepped surface 22 makes an opening small at the side of the front surface 16 of the terminal containing section 14. The inner surface 20a is integrally provided with a plurality of outer ribs 24a to 24c (three outer ribs in the present exemplary embodiment, as shown in FIG. 3).

Since the outer ribs 24a to 24c are the same configurations as one another, the outer rib 24b shown in FIG. 4 is described below as an example out of them. The outer rib 24b protrudes from the inner surface 20a. The outer rib 24b has a length that extends from an intermediate part of the inner surface 20a to the stepped surface 22 in an extending direction of the terminal containing section 14 (in upper and lower directions in FIG. 4). The outer rib 24b extends straightly in the extending direction of the terminal containing section 14. The outer rib 24b has a dimension in height from the inner surface 20a that increases gradually to the stepped surface 22 at a distal end side of an inserting direction of a connecting terminal 56 (mentioned after). As shown in FIG. 3, the outer rib 24b is formed so that a protruding end of the outer rib 24b from the inner surface 20a is a semicircular shape in cross section. The outer rib 24b is tapered so that a dimension in width at a distal end protruding from the inner surface 20a is smaller than a dimension in width at a side of the inner surface 20a. Furthermore, as shown in FIG. 5, it will be apparent from outer ribs 24d and 24e (mentioned after) having the same configuration as that of the outer rib 24b that the outer rib 24b is tapered so that a dimension in width (right and left directions in FIG. 5) decreases gradually toward the rear surface 18.

As shown in FIG. 3, the outer rib 24b out of the outer ribs 24a, 24b, and 24c that have the same configurations is located on a central position in a width direction (right and left directions in FIG. 3). The outer ribs 24a and 24c are spaced apart from each other by an equal distance with respect to the outer rib 24b so that the outer ribs 24a and 24c are disposed at both sides of the outer rib 24b. The outer ribs 24a, 24b, and 24c are disposed at the same positions from one another in a thickness direction of the electrical junction box 10 (in upper and lower directions in FIG. 4).

On the other hand, as shown in FIGS. 2, 4, and 5, the inner surfaces 20b and 20d are provided with projecting walls 28a and 28b that protrude inward in the terminal containing section 14. As shown in FIG. 2, the projecting walls 28a and 28b protrude from the inner surfaces 20b and 20d so that the walls 28a and 28b approach to each other. Projecting edges of the projecting walls 28a and 28b are spaced apart from each other so that they sandwich a lance 34 (mentioned after) in a top plan view. Surfaces of the projecting edges of the projecting walls 28a and 28b that are opposed to the inner surface 20a define the inner surface 20c of the terminal containing section 14.

The projecting walls 28a and 28b are integrally provided on the inner surface 20c with the outer ribs 24d and 24e. The outer ribs 24d and 24e substantially have the same configurations as those of the outer ribs 24a to 24c on the inner surface 20a. The outer ribs 24d and 24e are provided on the distal end edges protruding from the inner surfaces 20b and 20d of the projecting walls 28a and 28b. As shown in FIG. 4, the outer ribs 24d and 24e are located at the same positions of the outer ribs 24a to 24c in the extending direction of the terminal containing section 14 (in the upper and lower directions in FIG. 4) and extend straightly in the extending direction of the terminal containing section 14. The outer ribs 24d and 24e have dimensions protruding from the inner surface 20c so that the dimensions increase gradually from the front end edge at the side of the rear surface 18 to the side of the front surface 16 that is the front end side in the connecting terminal 56 (mentioned after), as is the case with the outer ribs 24a to 24c. Furthermore, the outer ribs 24d and 24e extend from the positions that are equal to the stepped surface 22 on the inner surface 22a in the extending direction of the terminal containing section 14 to the front surface 16 so that the outer ribs 24d and 24e have the constant cross section. As shown in FIG. 3, the outer ribs 24d and 24e are faced to the outer ribs 24a and 24e slightly outside the terminal containing section 14.

As shown in FIG. 4, the projecting walls 28a and 28b are provided on their ends at the side of the rear surface 18 on the inner surface 20c with slant surfaces 30, 30 that are spaced apart from the inner surface 20a as the slant surfaces 30 and 30 approach to the rear surface 18. On the other hand, the inner surface 20a is provided with a similar slant surface 32. Since the slant surfaces 30 and 32 are faced to one another at the same positions in the extending direction of the terminal containing section 14, the terminal containing section 14 is widened at the side of the rear surface 18 by the slant surfaces 30 and 32. Accordingly, a distance between the inner surfaces 20a and 20c decreases gradually from the rear surface 18 to the front surface 16 from the slant surfaces 30 and 32, and then is substantially constant from the slant surfaces 30 and 32 to the outer ribs 24a to 24e, and again decreases gradually from the outer ribs 24a to 24e.

A lance 34 is provided in a space between the projecting walls 28a and 28b so as to serve as an engaging and holding section. The lance 34 can adopt any one of publicly known configurations in the prior art. The terminal containing section 14 in the present embodiment is provided at a position remote from the inner surface 20e with a second inner surface 20e that is opposed to the inner surface 20a. The lance 34 protrudes from the second inner surface 20e. The lance 34 protrudes from the second inner surface 20e at a connecting portion 36 and has a leaf spring section 38 that extends from the connecting portion 36 to the front surface 16. The leaf spring section 38 is inclined so that the leaf spring section 38 approaches to the inner surface 20a as the section 38 extends from the connecting portion 36 to the front surface 16.

An engagement projection 40 that protrudes toward the inner surface 20a is integrally provided on a projecting end from the connecting portion 36 on the leaf spring section 38. A surface of the engagement projection 40 at a side of the rear surface 18 defines a slant guide surface 42 in which a dimension projecting from the leaf spring section 38 increases gradually as the slant guide surface 42 extends from the side of the rear surface 18 to the side of the front surface 16. On the other hand, a surface of the engagement projection 40 at the side of the front surface 16 defines an engagement surface 44 that inclines in the same direction as the slant guide surface 42 by a slant angle smaller than that of the slant guide surface 42. The leaf spring section 38 is provided on a projecting end edge with an operation piece 46 having a triangular shape in cross section so that the operation piece 46 inclines and is spaced apart from the engagement projection 40. Under an engagement condition of the connecting terminal 56 (mentioned after) with the terminal containing section 14, a suitable tool or the like is inserted into the terminal containing section 14 from the side of the front surface 16 to operate the operation piece 46, if required, then the lance 34 is brought into approach to the second inner surface 20e. In result, it is possible to release an engagement condition between the lance 34 and the connecting terminal 56. As shown in FIG. 3, since the lance 34 is disposed between the outer ribs 24d and 24e, the lance 34 is opposed to the outer rib 24b.

On the other hand, as shown in FIG. 5, the inner surfaces 20b and 20d of the terminal containing section 14 are substantially flat surfaces through a whole length of the terminal containing section 14. As shown in FIG. 3, a pair of projecting plates 48a and 48b are provided on the inner surfaces 20b and 20d, respectively. Side ribs 50a and 50b protrude from the projecting plates 48a and 48b, respectively.

The projecting plates 48a and 48b are provided on the inner surfaces 20b and 20d, respectively. The projecting plate 48a is disposed at the side of the inner surface 20a while the projecting plate 48b is disposed at the side of the inner surface 20c. The projecting plates 48a and 48b protrude from the inner surfaces 20b and 20d in a direction approaching to each other and are formed into plate-like configurations that extend in a longitudinal direction of the terminal containing section 14. As shown in FIG. 5, the projecting plates 48a and 48b extend in the extending direction of the terminal containing section 14 at the same positions of the outer ribs 24d and 24e and have the same lengths as the outer ribs 24d and 24e. Dimensions of the projecting plates 48a and 48b that protrude from the inner surfaces 20b and 20d are substantially constant through entire lengths of the projecting plates 48a and 48b. The inner surfaces 20b and 20d are provided with grooves 52 (see FIGS. 2 and 5) between the pair of the projecting plates 48a and 48b. The projecting plates 48a and 48b are spaced apart from each other in the facing direction of the inner surfaces 20a and 20c (in the upper and lower directions in FIG. 3).

The projecting plates 48a and 48b are integrally provided with side ribs 50a and 50b, respectively. The side ribs 50a and 50b extend through the entire lengths of the projecting plates 48a and 48b in the extending direction of the terminal containing section 14. As shown in FIGS. 3 and 4, the side ribs 50a and 50b are provided on end edges near the other projecting plate 48a (48b) on projecting end surfaces of the projecting plates 48a and 48b from the inner surface 20b and 20d. The end edge of the projecting plate 48a at the side of the front surface 16 is connected to the stepped surface 22 while the end edge of the side rib 50a at the side of the front surface 16 is connected to the projecting end edge of the stepped surface 22 from the inner surface 20a.

The side ribs 50a and 50b are formed into substantially semicircular shapes in cross section and protrude from the projecting plates 48a and 48b. The side ribs 50a and 50b are tapered so that dimensions in width of the projecting end of the side ribs 50a and 50b (dimensions in the upper and lower directions in FIG. 3) are smaller than those of the sides of the inner surfaces 20b and 20d. As shown in FIG. 4, the side ribs 50a and 50b are tapered at their front ends 54 at the side of the rear surface 18 so that dimensions in width decrease toward the rear surface 18. The side ribs 50a and 50b have substantially constant cross sections from the front ends 54 to the front surface 16.

As shown in FIGS. 4 and 5, end edges of the side ribs 50a and 50b and outer ribs 24a to 24e at the side of the rear surface 18 are disposed at the same positions in the extending direction of the terminal containing section 14. As shown in FIGS. 3 and 5, cross section areas of the outer ribs 24a to 24e are set to be greater than those of the side ribs 50a and 50b at the same positions in the extending direction of the terminal containing section 14 through the entire lengths of the outer ribs 24a to 24e. That is, the outer ribs 24a to 24e have dimensions in width and cross section areas than those of the side ribs 50a and 50b, as a whole.

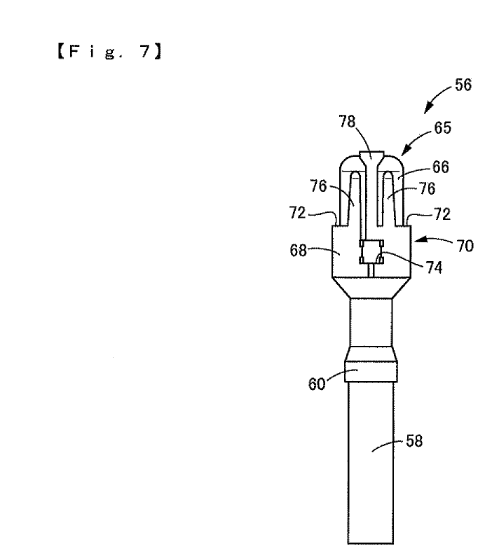

The connecting terminal 56 shown in, for example, FIGS. 6 to 8 is inserted into the terminal containing section 14 constructed above. The connecting terminal 56 will be briefly described below.

The connecting terminal 56 is coupled to an end of an electrical cable 58. The connecting terminal 56 is provided with a caulking piece 60 for an electrical cable 58 and a caulking piece 62 for core wires 64. The caulking piece 60 is secured to the electrical cable 58 by caulking the caulking piece 60 to clamp the end of the electrical cable 58. The caulking piece 62 is caulked onto core wires 64 of the electrical cable 58 to clamp the core wires 64, thereby electrically coupling the connecting terminal 56 to the core wires 64.

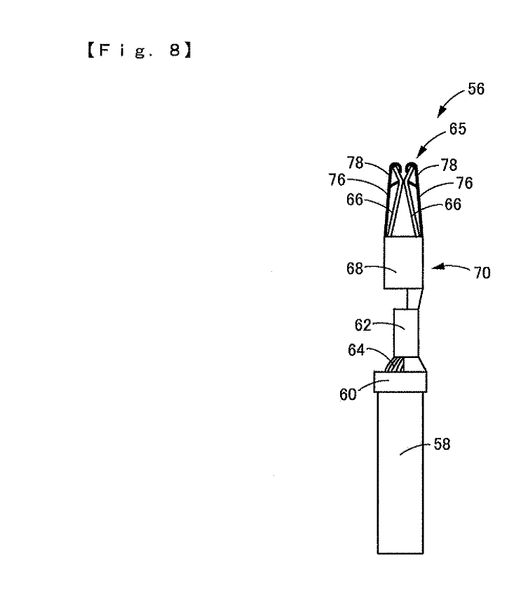

The connecting terminal 56 is provided on its distal end with a pair of pinching pieces 66, 66. Each of the pinching pieces 66, 66 is formed into a substantially rectangular plate-like configuration that has a substantially constant dimension in width (right and left directions in FIG. 7). The pinching pieces 66, 66 approach each other as the pieces 66, 66 extend to a side of a distal end portion 65 of the connecting terminal 56 (an upper end in FIG. 8) and stack on each other at the distal end portion 65. Thus, the distal end portion 65 of the connecting terminal 56 is tapered in a side elevation view (see FIG. 8). The distal ends of the pinching pieces 66, 66 are bent to be spaced apart from each other to easily receive a tab terminal of a relay (not shown) in a space between the pinching pieces 66, 66. The pinching pieces 66, 66 are formed by bending a metal sheet made of copper that is worked by a press-punching means so that the pinching pieces 66, 66 are integrally formed with the caulking piece 60 for the electrical cable 58 and caulking piece 62 for the core wires 64.

Furthermore, a holding member 68 is attached to a metal sheet that forms the pinching pieces 66, 66. The holding member 68 are formed by winding a metal sheet, such as a stainless steel or the like, worked by, for example, a press-punching means around the metal sheet that constitutes the pinching pieces 66, 66. Thus, a substantially rectangular box-like main body 70 is provided in a part between the pinching pieces 66, 66 and the caulking piece 62 for the core wires 64. The pinching pieces 66, 66 protrude from the main body 70. As shown in FIG. 7, dimensions in width of the pinching pieces 66, 66 are set to be smaller than those of the main body 70, and stepped portions 72, 72 are provided on the main body 70 at both sides of the pinching pieces 66, 66. Further, rectangular engagement apertures 74, 74 are provided on both sides of main body 70.

The holding member 68 is provided with widening stopper pieces 76 that protrude from the main body 70. A pair of widening stopper pieces 76 are provided on each of the pinching pieces 66, 66 to be disposed at an outside position in the stacking direction of the pinching pieces 66, 66 (right and left directions in FIG. 8). Distal ends of the widening stopper pieces 76 that protrude from the main body 70 are bent to the sides of the pinching pieces 66, 66. Furthermore, the holding member 68 is provided with a holding arm 78 for each of pinching pieces 66, 66. The holding arm 78 protrudes from the main body 70 to extend between the widening stopper pieces 76, 76. As shown in FIG. 8, a projecting distal end edge of each holding member 78 is bent in a direction reverse to the projecting direction so as to be engaged with the distal end edge of each pinching piece 66. When the widening stopper pieces 76 contact with the pinching pieces 66, 66 and the holding arms 78 are engaged with the pinching pieces 66, 66, the pinching pieces are prevented from being widened excessively, thereby maintaining a connecting action of the pinching pieces 66, 66 for a long period in time.

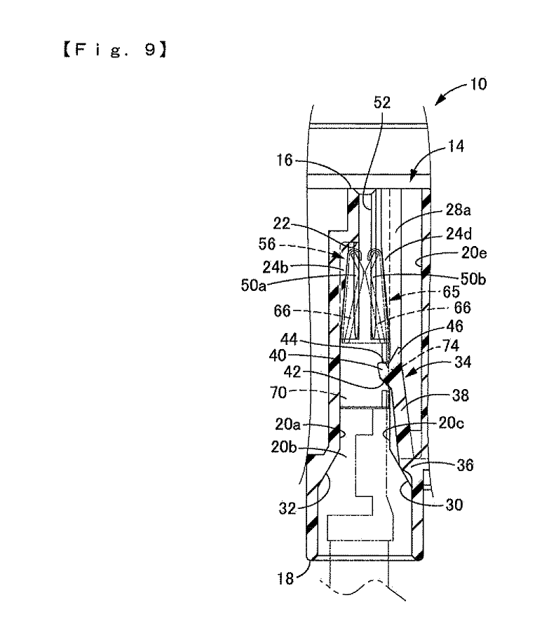

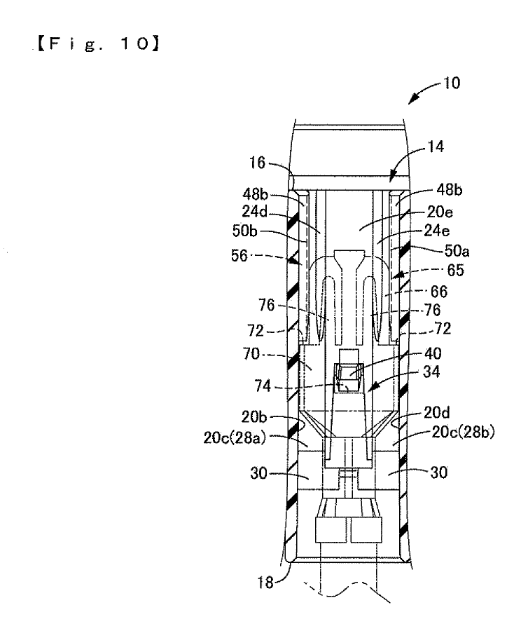

As shown in FIGS. 9 and 10, the connecting terminal 56 constructed above is inserted into the terminal containing section 14 from the rear surface 18 toward the front surface 16 while the pinching pieces 66, 66 are being directed forward. When the connecting terminal 56 is inserted into the terminal containing section 14, the engagement projection 40 of the lance 34 contacts with the connecting terminal 56 and the leaf spring section 38 is biased toward the second inner surface 20e. When the connection terminal 56 is further inserted into the terminal containing section 14, the engagement projection 40 of the lance 34 is fitted into the engagement aperture 74 by an elastic restoring force of the leaf spring section 38. Consequently, the connecting terminal 56 is latched by the lance 34, so that the connecting terminal 56 is held in the terminal containing section 14. Since the slant guide surface 42 of the engagement projection 40 is inclined in an inserting direction of the connecting terminal 56, the leaf spring section 38 can be easily deflected toward the second inner surface 20e of the terminal containing section 14. Since the engagement surface 44 of the engagement projection 40 is inclined in a direction opposite from a withdrawing direction of the connecting terminal 56 (in a lower direction in FIG. 9), it is possible to stably latch the connecting terminal 56 in the terminal containing section 14.

As shown in FIGS. 9 and 10, when the connecting terminal 56 is accommodated in the terminal containing section 14, the distal end 65 of the connecting terminal 56 is accommodated in a space surrounded by the outer ribs 24a to 24e and side ribs 50a, 50b. Thus, the pair of pinching pieces 66, 66 are pinched by the outer ribs 24a, 24e and the outer ribs 24c, 24d that are opposed to each other (see FIG. 3) from both sides in the stacking direction (in the right and left directions in FIG. 9). Furthermore, in the present embodiment, the outer rib 24b is opposed to the lance 34 and the connecting terminal 56 is pinched between the lance 34 and the outer rib 24b. In association with the fact that the pinching pieces 66, 66 are gradually spaced apart from the inner surfaces 20a and 20c as the pieces 66, 66 extend to the side of the front surface 16, the outer ribs 24a to 24e protrude gradually from the inner surfaces 20a and 20c. Consequently, clearances between the inner surfaces 20a and 20c and the pinching pieces 66, 66 can be eliminated. Accordingly, the distal end 65 is positioned in the terminal containing section 14 in the stacking direction of the pinching pieces 66, 66 (in the right and left directions in FIG. 9). Since the biasing force exerted in the connecting terminal 56 by the lance 34 is supported by the outer rib 24b, it is possible to more effectively restrain the distal end 65 from staggering in the terminal containing section 14.

The main body 70 of the connecting terminal 56 is disposed in a space among the outer ribs 24a to 24e, the side ribs 50a and 50b, and the slant surfaces 30 and 32 in the extending direction of the terminal containing section 14 so as to be accommodated in the section 14 without substantially causing any clearance. As shown in FIG. 10, the projecting plates 48a and 48b are fitted into the clearance between the pinching pieces 66, 66 and the inner surfaces 20b, 20d. Thus, the pinching pieces 66, 66 are pinched by the side ribs 50a and 50b provided on the projecting plates 48a and 48b from both sides in the direction perpendicular to the stacking direction (in the right and left directions in FIG. 10). In result, the distal end 65 is positioned in the terminal containing section 14 in the direction perpendicular to the stacking direction of the pinching pieces 66, 66 (in the right and left directions in FIG. 10).

When an electrical component, for example, a relay tab terminal (not shown) is inserted into the terminal containing section 14 from the side of the front surface 16, the relay tab terminal is inserted into a space between the stacking surfaces of the pinching pieces 66, 66 while the relay tab terminal is widening the space between the pinching pieces 66, 66. The relay tab terminal is pinched by an elastic restoring force of the pinching pieces 66, 66, thereby electrical coupling the relay tab terminal to the connecting terminal 56.

According to the electrical junction box 10 of the present embodiment, the distal end 65 of the connecting terminal 56 held in the terminal containing section 14 is pinched by the outer ribs 24a to 24e and the side ribs 50a and 50b in the stacking direction of the pinching pieces 66, 66 and in the direction perpendicular to the stacking direction and is positioned in the terminal containing section 14. Thus, it is possible to prevent the distal end 65 from staggering in the terminal containing section 14 and to stably carry out operations of inserting and withdrawing the relay tab terminal into and from the connecting terminal 56.

In particular, as shown in FIGS. 9 and 10, the outer ribs 24a to 24e are brought in to contact with the faces of the pinching pieces 66, 66 from the outside in the widening direction and over wide areas in the longitudinal direction of the outer ribs 24a to 24e. Thus, it is possible for the outer ribs 24a to 24e to stably prevent the pinching pieces 66, 66 from being excessively deformed and it is possible to ensure a connecting performance of the pinching pieces 66, 66 for a long period in time. Particularly, in the present embodiment, the outer ribs 24a, 24c, 24d, and 24e contact with the widening stopper pieces 76 of the connecting terminal 56. The outer ribs 24a, 24c, 24d, and 24e cooperate with the widening stopper pieces 76, so that a pinching force for the relay tab terminal can be ensured stably while effectively preventing the pinching pieces 66, 66 from being excessively deformed.

On the contrary, as shown in FIG. 9, the side ribs 50a and 50b intersect the pinching pieces 66, 66 so as to be brought into point contact with the pinching pieces 66, 66. Thus, it is possible to reduce a contact area between the side ribs 50a, 50b and the pinching pieces 66, 66 as small as possible, it is possible to lower a deleterious effect to opening and closing actions of the pinching pieces 66, 66, and it is possible to prevent the distal end 65 from staggering in the terminal containing section 14.

The sizes of the outer ribs 24a to 24e are greater than those of the side ribs 50a and 50b. Thus, the outer ribs 24a to 24e can prevent the pinching pieces 66, 66 from being excessively deformed while the smaller ribs 50a and 50b can reduce a deleterious effect caused by opening and closing actions of the pinching pieces 66, 66, and can prevent the distal end 65 from staggering in the terminal containing section 14. Furthermore, since the outer ribs 24a to 24e and the side ribs 50a, 50b are tapered, it is possible to prevent the connecting terminal 56 in the terminal containing section 14 while permitting the pinching pieces 66, 66 to be deformed on account of connection of the relay tab terminal.

Furthermore, since the outer ribs 24d and 24e are provided on the projecting walls 28a and 28b, the projecting walls 28a and 28b will be deflected slightly. Thus, a possibility that excessive deformation of the pinching pieces 66, 66 can be reduced by the outer ribs 24d and 24e. The outer ribs 24d and 24e are brought into contact with the pinching pieces 66, 66 by utilizing the elastic restoring force of the projecting walls 28a and 28b and the holding force of the pinching pieces 66, 66 can be stably ensured.

Since the outer ribs 24a to 24e and side ribs 50a and 50b decrease the clearance between the inner surfaces 20a to 20e and the connecting terminal 56, it is possible to reduce a required amount of resin in comparison with the case where the whole of the inner surfaces 20a to 20e are tapered in correspondence with the distal end 65 of the connecting terminal 56. Since the outer ribs 24a to 24e and side ribs 50a and 50b contact with the connecting terminal 56, it is possible to reduce a contact area between the connecting terminal 56 and the terminal containing section 14, thereby decreasing an inserting force of the connecting terminal 56 into the terminal containing section 14. Particularly, since the outer ribs 24a to 24e and side ribs 50a and 50b are tapered, it is possible to further reduce the inserting force of the connecting terminal 56. The terminal containing section 14 in the present embodiment is widened at the side of the rear surface 18 by the slant surfaces 30 and 32. Thus, when the connecting terminal 56 is inserted into the terminal containing section 14, firstly the connecting terminal 56 is roughly positioned by the slant surfaces 30 and 32 and then the outer ribs 24a to 24e and side ribs 50a and 50b can position the connecting terminal 56 more precisely.

Although the exemplary embodiments are described in detail above, it should be noted that the present disclosure is not limited to the above exemplary embodiments. For example, specific shapes and numbers of the outer and side ribs are not limited to those of the above exemplary embodiments. Accordingly, the pair of outer ribs that pinch both sides of the pinching pieces in the stacking direction of the pinching pieces are not always opposed to each other in the stacking direction of the pinching pieces. For example, in the above embodiment, the outer ribs 24a and 24c (see FIG. 3) may be eliminated and the outer ribs 24b, 24d, and 24e may pinch the pinching pieces 66, 66.

Although the outer ribs 24d and 24e are provided on the projecting walls 28a and 28b and are disposed on a plane different from the lance 34 in the above exemplary embodiments, the outer ribs 24d, 24e and lance 34 may be disposed on the same plane.

Furthermore, the connecting terminal is not limited to a terminal to which a relay is connected. For example, the connecting terminal can be selected from any one of terminals to which various electrical components such as a fuse or a fusible link are coupled, if required.

What is claimed is:

1. An electrical junction box comprising:
a terminal containing section configured to hold a connecting terminal that is configured to be connected to an electrical component, wherein
the connecting terminal is tapered and includes a pair of pinching pieces arranged adjacent to one another so as to oppose each other in a first direction, the connecting terminal configured to pinch a tab terminal of the electrical component between the pair of pinching pieces;
the terminal containing section further includes a plurality of outer ribs and a plurality of side ribs provided on an inner surface of the terminal containing section so as to protrude from the inner surface and extend in an inserting direction of the connecting terminal such that an amount of protrusion of the outer ribs gradually increases as the outer ribs extend toward a distal end side of the connecting terminal;
the outer ribs are configured to pinch the pair of pinching pieces in the first direction; and
the side ribs are configured to pinch the connecting terminal in a direction perpendicular to the first direction, thereby positioning the connecting terminal in the terminal containing section.

2. The electrical junction box according to claim 1, wherein the terminal containing section further includes an engaging and holding section on the inner surface of the terminal containing section that is configured to latch the connecting terminal, wherein the connecting terminal is pinched between the engaging and holding section and one of the outer ribs.

3. The electrical junction box according to claim 1, wherein the outer ribs are larger than the side ribs.

4. The electrical junction box according to claim 1, wherein the outer ribs are brought into contact along a planar surface of each of the pinching pieces in the first direction, while the side ribs are brought into contact with an edge of each of the planar surfaces of the pinching pieces in the direction perpendicular to the first direction.

5. The electrical junction box according to claim 2, wherein the outer ribs are larger than the side ribs.

6. The electrical junction box according to claim 2, wherein the outer ribs are brought into contact along a planar surface of each of the pinching pieces in the first direction, while the side ribs are brought into contact with an edge of each of the planar surfaces of the pinching pieces in the direction perpendicular to the first direction.

7. The electrical junction box according to claim 3, wherein the outer ribs are brought into contact along a planar surface of each of the pinching pieces in the first direction, while the side ribs are brought into contact with an edge of each of the planar surfaces of the pinching pieces in the direction perpendicular to the first direction.
